(19) United States
(12) Patent Application Publication
(10) Pub. No.: US 2015/0003050 A1
(43) Pub. Date: Jan. 1, 2015

(54) FLASHLIGHT WITH HIDDEN CHARGE PLUG

(71) Applicant: Kevin Parsons, Appleton, WI (US)

(72) Inventor: Kevin Parsons, Appleton, WI (US)

(73) Assignee: Armament Systems and Procedures, Inc.

(21) Appl. No.: 13/932,205

(22) Filed: Jul. 1, 2013

(51) Int. Cl. F21L 4/00; F21L 4/08

(52) U.S. Cl. CPC F21L 4/00; F21L 4/08
USPC 362/158

(57) ABSTRACT

A flashlight is described. The flashlight includes an elongated cylindrical housing with an external thread concentric with the longitudinal axis of the elongated cylindrical housing, the external thread is disposed on a marginal edge of a first end of the cylindrical housing, a light source within the elongated cylindrical housing on a first end, the light source emits light outwards from the elongated cylindrical housing along an axis concentric with the longitudinal axis, an O-ring concentric with the longitudinal axis set back from the first end, a micro USB receptacle extending through the elongated cylindrical housing between the first end and O-ring and a waterproof transparent cap with an internal thread set back from an engaging end of the waterproof transparent cap, the waterproof transparent cap is screwed onto the elongated cylindrical body to engage the O-ring and form a waterproof seal between the waterproof transparent cap and elongated cylindrical housing and is unscrewed to expose the micro USB connector for receipt of electrical energy through the micro USB connector that powers the light source.

### RELATED PATENTS

This Application is related to U.S. Pat. No. 7,581,848 filed on May 31, 2007 and issued on Sep. 1, 2009 and assigned to the same assignee as the instant Application. U.S. Pat. No. 7,581,848 is incorporated into this Application as if fully set forth herein.

### FIELD

The field of the invention relates to flashlights and more particularly to rechargeable flashlights.

### BACKGROUND

Flashlights are generally known. Flashlights are generally constructed with a housing that holds a set of batteries. A switch and light source is typically located on an outer surface of the housing. The switch is connected in series with the light source and batteries.

Flashlights relied upon by the police and/or the military are used in different ways and have different requirements than flashlights used by civilians. For example, police or military personnel are often required to carry a great deal of equipment in order to achieve their assigned goals. Because of the equipment carried by police or military personnel, the size, weight and configuration of a flashlight is of critical importance. If a flashlight is bulky or heavy, then the flashlight may be left behind. If the officer or military person is suddenly confronted by a threat in a darkened area, the absence of a flashlight could place the person's life in peril.

A flashlight carried by police or military personnel must also be reliable. In this regard, light sources (e.g., bulbs) that could easily burn out from use or are easily damaged from shock cannot be tolerated. In addition, the flashlight must provide a superior light output to weight ratio with a predictably long battery life and convenient means for replenishing depleted batteries.

Moreover, flashlights used by police or military personnel should not easily become weapons that can be used against the carrier. For this reason, a flashlight used by a police officer or military person should be compact and relatively small. However, even in keeping with the concept of small size, the flashlight should be adaptable to different battery configurations in order to accomplish different missions without loss of utility. Accordingly, a need exists for a flashlight that is small, yet adaptable, for the needs of police and military personnel.

### BRIEF DESCRIPTION OF THE DRAWINGS

FIG. 1A-B are perspective views of the flashlight under illustrated embodiments with FIG. 1A displaying a configuration during normal use and FIG. 1B displaying a configuration when being charged;

FIG. 2 is an exploded view of the flashlight of FIG. 1;

FIG. 3 is a cut-away view of the cap of the flashlight of FIG. 1;

FIGS. 4A-B are cut-away views of the flashlight of FIGS. 1A-B where FIG. 4A shows a normal cut-away view and FIG. 4B shows a cut-away view with the cap extended;

FIG. 5A-B shows end views of a battery that may be used with the flashlight of FIG. 1 where FIG. 5A shows a perspective view and FIG. 5B shows a perspective cut-away view; and

FIG. 6 is a circuit diagram of the flashlight of FIG. 1.

### DETAIL DESCRIPTION OF AN ILLUSTRATED EMBODIMENT

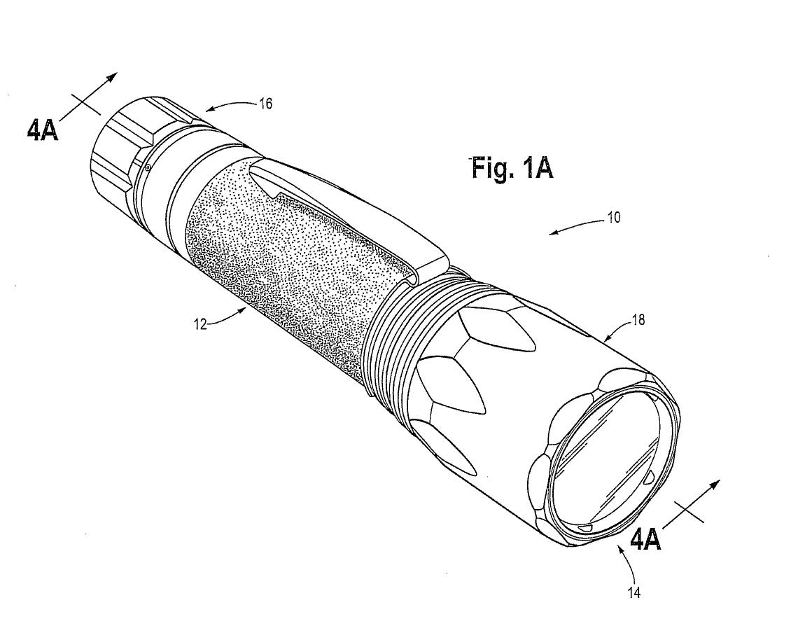

FIGS. 1A and 1B are a perspective view of a rechargeable flashlight 10 shown generally in accordance with an illustrated embodiment. FIG. 1A shows the flashlight 10 during conditions of normal use and FIG. 1B shows the flashlight 10 in conjunction with a charging connector 20. The flashlight 10 is generally constructed to be waterproof and to allow for the use of a rechargeable battery or one or more non-rechargeable batteries.

The charging connector 20 includes a micro USB connector 22 on an end that engages a micro USB receptacle 30 of the flashlight 10 and a conventional USB plug 24 on the opposite end. The conventional USB plug 24 allows the flashlight 10 to be charged from any power source having a USB receptacle (e.g., laptop computer, desktop computer, etc.). The flashlight 10 may also be charged by connecting the USB plug 24 into a wall adapter 26 (i.e., receiving 110 vac from a wall outlet) or into a cigar lighter adapter 28 (i.e., receiving 12 vdc from an automobile).

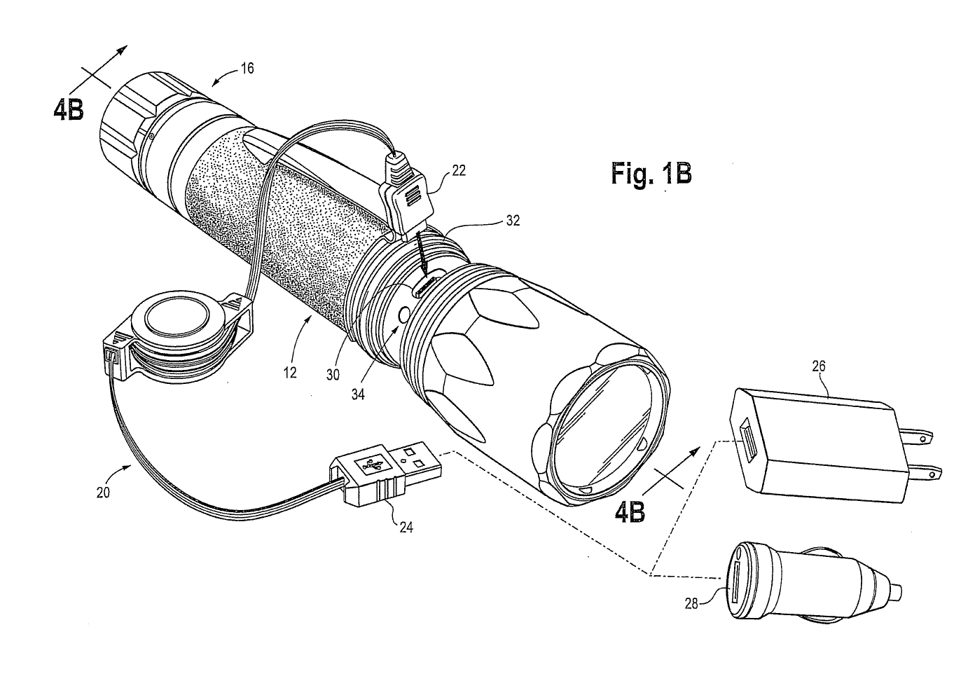

FIG. 2 is an exploded view of the flashlight of FIG. 1. As shown in FIGS. 1A, 1B and 2, the flashlight 10 is constructed with cylindrical body 12 with a light source 14 on one end and a switch assembly 16 on the second, opposite end. A waterproof cap 18 covers a first end of the cylindrical body 12 to protect the light source from damage and from water incursion.

In some embodiments, the switch assembly 16 may have a structure that is substantially the same as the switch assembly described in U.S. Pat. No. 7,581,848. In other embodiments, the switch assembly may differ.

The light source 14 may be powered by a rechargeable battery 200 or one or more non-rechargeable batteries 202, 204. In this regard, the batteries 200, 202, 204 may be inserted into the cylindrical body 12 of the flashlight 10 by removal of the switch assembly 16.

In the case where a rechargeable battery 200 is used, the battery 200 may be a lithium ion battery. Alternatively, conventional lithium, primary cell batteries 202, 204 may be used.

In the case of conventional lithium, primary cell batteries 202, 204, the housing 12 and contacts may be constructed with a size that accepts two CR123 lithium batteries where each provides 3 volts of output voltage. The rechargeable battery 200 has a size (i.e., diameter and length) that is substantially the same as two CR123 batteries placed in series. The contact structure of the battery 200 differs to accommodate the ability to recharge the battery 200.

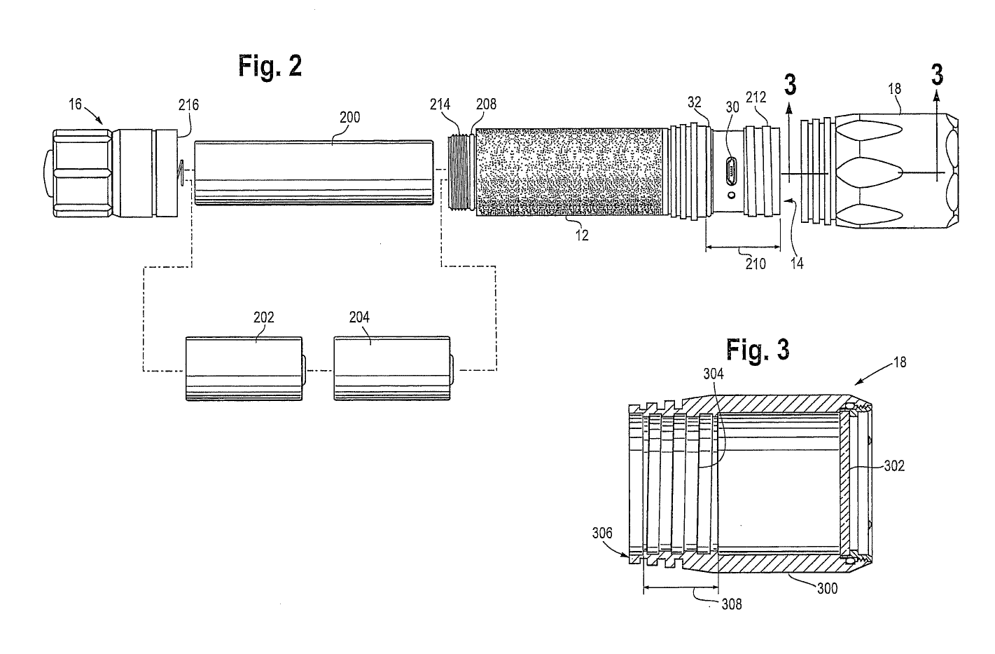

FIG. 3 is a cut-away view of the cap 18. As shown, the cap 18 includes a transparent lens 302 that is installed inside a cylindrical tube 300 and that forms a waterproof seal with the cylindrical tube 300. An internal thread 304 is also provided in a spaced-apart relationship with (or otherwise set back from) an engaging end 306 of the cap 18.

The waterproof cap 18 and switch assembly 16 are threaded onto the cylindrical body 12. A respective O-ring 32, 208 seals the threaded connection of each end against water incursion.

An external thread 212 on a first end of the housing 12 is provided to engage the cap 18. It should be noted in this regard that the threaded distance 308 of the internal thread 304 of the cap 18 is more than or equal to the distance 210 between the external thread 212 and O-ring 32. This ensures that as the internal thread 304 of the cap 18 is threaded onto the external thread 212 of the housing 12, the engaging end 306 of the cap 18 will engage the O-ring 32 as the cap 18 is screwed onto the body 12 thereby forming the waterproof seal between the cap 18 and body 12.

Similarly, an external thread 214 of the switch assembly 16 is screwed into an internal thread 216 inside the switch assembly 16. In this regard, the internal thread 216 must extends a sufficient distance from an engaging end of the switch assembly 16 into the switch assembly 16 such that the engaging end of the switch assembly 16 engages the O-ring 208 thereby forming a waterproof seal between the switch assembly 16 and housing 12.

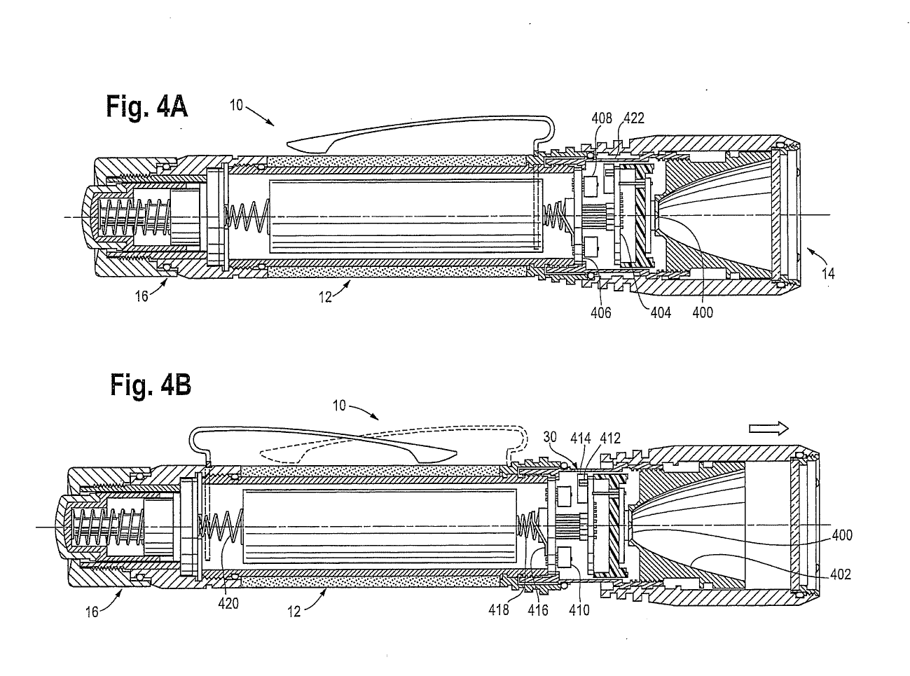

FIGS. 4A and 4B are partial cut-away views of the flashlight 10. Similar to FIGS. 1A and 1B, FIGS. 4A is a cut-away view of the flashlight 10 in condition of normal use and FIG. 4B is a cut-away view with the cap 18 extended so that the charging plug 22 can be inserted into the charging receptacle 30.

In this regard, the light source 14 includes a high performance LED 400 (e.g. a Cree model XPG LED) capable of light output of at least 200 lumens. The LED 400 and corresponding reflector 402 are rigidly coupled to and form a portion of the housing 12.

Power from the battery 200, 202, 204 is coupled to the LED 400 via the switch assembly 16 and one or more printed circuit boards 404, 406. Included on the circuit boards 404, 406 may be any of a number of different electronic devices 408, 410. One or more of the devices may be computer processors 408, 410 (e.g., made by Intel). Another of the devices may be a memory 408, 410. In this regard, the one or more processors 408, 410 may execute instructions of one or more computer programs loaded from a non-transitory computer readable medium (e.g., memory 408, 410).

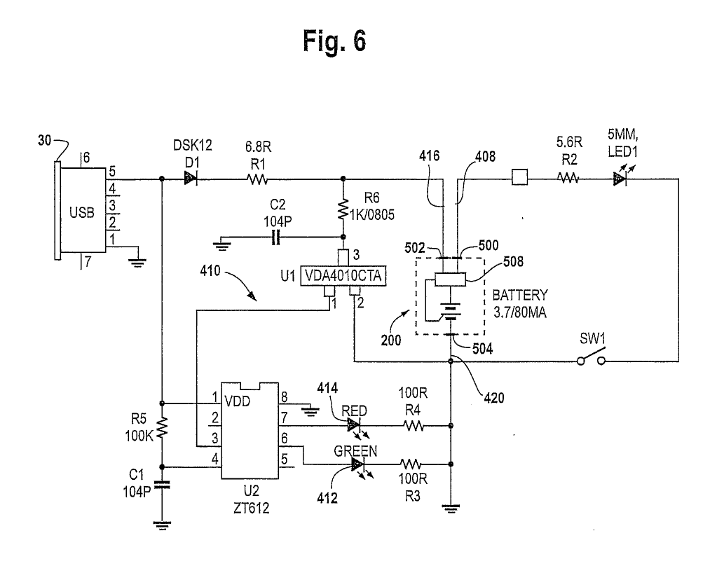

FIG. 6 shows an example of the circuitry of the flashlight 10. Included on at least one of the circuit boards 404, 406 may be buck and boost circuitry 408, 410 that maintains a constant voltage/current to the LED 400. The buck and boost circuitry ensures that the light output from the flashlight 12 remains relatively constant between full charge of the batteries and near complete depletion of the battery 200, 202, 204.

Also included on one of the printed circuit boards 404, 406 may be control circuitry (IC2) 408, 410. As shown in FIG. 6, the control circuitry receives an ON or OFF signal from the switch 16 and that alternatively activates and deactivates the LED 400 via the buck and boost circuitry. In this regard, the charge control circuitry may detect a battery voltage via a charging module U1 and modulate the buck and boost circuitry in response to a signal from the switch 16 based upon the charge level of the battery.

In some embodiments, the operation of the circuitry 408 in conjunction with the switch assembly 16 may have a structure and operation that is substantially the same as that described in U.S. Pat. No. 5,581,848. In other embodiments, the switch assembly differs.

Under one illustrated embodiment, the control circuitry of IC2 may include a processor that operates under control of a computer program loaded from a non-transitory computer readable medium located within the IC2. In this regard, the processor receives an ON/OFF signal from the switch 16 and modulates the current to the LED 400 via the buck and boost circuitry based upon battery voltage and a predetermined voltage/current that optimizes light output from the LED 400.

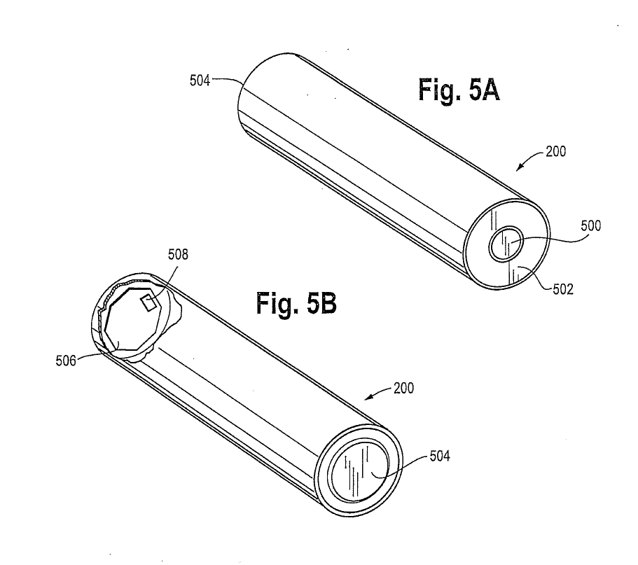

Also included on at least one of the circuit boards 404, 406 is charge control circuitry 410. In this regard, operation of the charging circuitry is dependent upon the type of battery 200, 202, 204 that is used within the flashlight 10. For example, conventional lithium batteries 202, 204 represent a substantial safety risk if an attempt is made to recharge the batteries 202, 204. In order to accommodate the use of different batteries 200, 202, 204 within the flashlight 10, the rechargeable battery 200 has the unique contact structure shown in FIGS. 5A and 5B. In this regard, the rechargeable battery has three contacts 500, 502, 504. In contrast, a conventional lithium, primary cell battery 202, 202 has only two contacts (i.e., contacts 500 and 504 using FIG. 5 as an example).

The flashlight 10 also incorporates a contact structure including three terminals 416, 418, 420 to accommodate either a three contact battery 200 or a two contact battery 202, 204. In this regard, terminals 418 and 420 are coaxial with the housing 12 and are, therefore, situated to form a contact with contacts 500 and 504 on either battery 200 or batteries 202 and 204.

In contrast, the charging contact 416 is offset from the longitudinal center of the housing 12 and batteries 200, 202, 204. As such, the charging contact 416 can only form a contact with the terminal 502 of a rechargeable battery 200.

More specifically, non-rechargeable batteries 202, 204 do not have the contact 502. Accordingly, when non-rechargeable batteries 202, 204 are inserted into the flashlight 10, there is no contact 502 to engage the charging contact 416. Therefore the dangers associated with attempting to recharge a non-rechargeable battery are avoided by the structure of the flashlight 10.

Also included within the PCBs 404, 406 is a charging circuit 410, 410, including charge control circuitry (e.g., module U1 in FIG. 6) and a status indication processor executing within module U2. The charge status processor and associated circuitry detects a charging potential (via an input terminal 1) and deactivates an output (on terminal 3) to deactivate any current to the LED 400. The charge status processor may then detect a battery voltage via (output 1 of) the charge control module U1 and provides an indication of charge state via one of a red LED 414 or green LED light 412. In this regard, the red LED 414 is programmed to flash when the battery is charging. When the battery 200 achieves a full charge, the green LED 412 displays a steady green color. The use of the flashing red and steady green light is provided so that color blind people would not be confused as to the charge status.

In order to facilitate being able to easily see the status LEDs 412, 414, an aperture 34 is provided in the housing directly over the LEDs 412, 414 as shown in FIG. 1B. A hemispherical lens 422 (FIG. 4A) is provided inside the housing 12 over the aperture 34. The hemispherical lens 422 allows the LEDs 412, 414 to be offset from the aperture 34. In this case, the hemispherical lens 422 receives light from the LEDs 412, 414 at oblique angles and guides that light through the aperture 34 so that it can be easily observed by a user.

In order to further improve the safety and reliability of the flashlight 10, the rechargeable battery 200 may be provided with one or more circuit boards 506 inside the battery 200. The circuit boards 506 may include one or more safety circuits within a respective integrated circuit (IC) device 508.

The IC device 508 may be connected between terminal 500, 502 and the positive terminal of the battery as shown in FIG. 6 and may contain an active current control circuitry. In this configuration, the IC device 508 may respond to the excessive current conditions by disconnecting one or both of terminals 500, 502 from the positive terminal of the battery in response to an overcurrent condition.

In general, the flashlight described herein includes an elongated cylindrical housing with an external thread concentric with the longitudinal axis of the elongated cylindrical housing, the external thread is disposed on a marginal edge of a first end of the cylindrical housing, a light source within the elongated cylindrical housing on a first end, the light source emits light outwards from the elongated cylindrical housing along an axis concentric with the longitudinal axis, an O-ring concentric with the longitudinal axis set back from the first end, a micro USB receptacle extending through the elongated cylindrical housing between the first end and O-ring and a waterproof transparent cap with an internal thread set back from an engaging end of the waterproof transparent cap, the waterproof transparent cap is screwed onto the elongated cylindrical body to engage the O-ring and form a waterproof seal between the waterproof transparent cap and elongated cylindrical housing and is unscrewed to expose the micro USB connector for receipt of electrical energy through the micro USB connector that powers the light source.

In another embodiment, the flashlight includes a cylindrical housing having an external thread extending around the cylindrical housing proximate a first end, a LED light source disposed on the first end of the housing with an axis of light transmission of the LED parallel to the predominant axis of the cylindrical housing, an O-ring disposed around the housing spaced back from the first end, a micro USB receptacle extending through the cylindrical housing between the external thread and O-ring, a rechargeable battery within the cylindrical housing, an electrical switch that couples the rechargeable batter to the LED light, a waterproof cap with a transparent lens covering the LED light source and first end of the housing, the cylindrical housing having an internal thread spaced back from an engaging end of the waterproof cap, the internal thread of the waterproof cap being threaded onto the external thread of the housing by rotating the waterproof cap in a first direction relative to the cylindrical housing, the threading of the waterproof cap in the first direction causing the engaging end and waterproof cap to form a waterproof seal via the O-ring with the cylindrical housing, the waterproof cap being rotated in a second direction away from the O-ring to expose the USB receptacle thereby allowing the rechargeable battery to be charged via a charging current received through the USB receptacle.

In another embodiment, the flashlight includes a cylindrical housing having an external thread extending around the cylindrical housing proximate a first end, a LED light source disposed on the first end of the housing with an axis of light transmission of the LED parallel to the predominant axis of the light housing, an O-ring disposed around the housing spaced back from the first end, a micro USB receptacle extending through the cylindrical housing between the external thread and O-ring, a rechargeable battery within the cylindrical housing, a selector switch and pushbutton extending axially from the second end of the housing, the selector switch having a first position where the LED is momentarily activated for each momentary activation of the pushbutton, the selector switch having a second position where the pushbutton is momentarily activated a first time to activate and maintain the LED light in an activated state, the pushbutton being momentarily activated a second time to deactivate the LED light, a waterproof cap with a transparent lens covering the LED light source and first end of the housing, the cylindrical housing having an matching internal thread spaced back from an engaging end of the waterproof cap, the internal thread of the waterproof cap being threaded onto the external thread of the housing in a first direction to engage the O-ring to form a waterproof seal with the cylindrical housing, the waterproof cap being rotated in a second direction away from the O-ring to expose the USB receptacle thereby allowing the rechargeable battery to be charged via a charging current received through the USB receptacle.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A flashlight comprising:
a cylindrical housing having an external thread extending around the cylindrical housing proximate a first end;
a LED light source disposed on the first end of the housing with an axis of light transmission of the LED parallel to the predominant axis of the cylindrical housing;
an O-ring disposed around the housing spaced back from the first end;
a micro USB receptacle extending through the cylindrical housing between the external thread and O-ring;
a rechargeable battery within the cylindrical housing;
an electrical switch that couples the rechargeable batter to the LED light;
a waterproof cap with a transparent lens covering the LED light source and first end of the housing, the cylindrical housing having an internal thread spaced back from an engaging end of the waterproof cap, the internal thread of the waterproof cap being threaded onto the external thread of the housing by rotating the waterproof cap in a first direction relative to the cylindrical housing, the threading of the waterproof cap in the first direction causing the engaging end and waterproof cap to form a waterproof seal via the O-ring with the cylindrical housing, the waterproof cap being rotated in a second direction away from the O-ring to expose the USB receptacle thereby allowing the rechargeable battery to be charged via a charging current received through the USB receptacle.

2. The flashlight as in claim 1 further comprising a charge indicator light disposed between the external thread and O-ring and adjacent the micro USB receptacle that indicates a charge state of the rechargeable battery.

3. The flashlight as in claim 2 further comprising a charge status circuit that activates the charge indicator light based upon the charge status of the rechargeable battery.

4. The flashlight as in claim 3 wherein the charge indicator light further comprises a flashing red indicator light that is activated by the charge status circuit detecting that the rechargeable battery is less than fully charged.

5. The flashlight as in claim 3 wherein the charge indicator light further comprises a steady green indicator light that is activated by the charge status circuit detecting that the rechargeable battery is fully charged.

6. The flashlight as in claim 1 wherein the rechargeable battery further comprises a lithium ion battery.

7. The flashlight as in claim 1 further comprising a first terminal of a first polarity proximate the first end, the second terminal of a second polarity proximate the second end, the first and second terminals being concentric with the longitudinal axis of the cylindrical housing and a third terminal of the second polarity located adjacent the first terminal midway between the first terminal and wall of the cylindrical housing where the rechargeable battery receives charging energy through the first and third terminals and where the light source receives illuminating energy through the first and second terminals.

8. A flashlight comprising:
an elongated cylindrical housing with an external thread concentric with the longitudinal axis of the elongated cylindrical housing, the external thread is disposed on a marginal edge of a first end of the cylindrical housing;
a light source within the elongated cylindrical housing on a first end, the light source emits light outwards from the elongated cylindrical housing along an axis concentric with the longitudinal axis;
an O-ring concentric with the longitudinal axis set back from the first end;
a micro USB receptacle extending through the elongated cylindrical housing between the first end and O-ring; and
a waterproof transparent cap with an internal thread set back from an engaging end of the waterproof transparent cap, the waterproof transparent cap is screwed onto the elongated cylindrical body to engage the O-ring and form a waterproof seal between the waterproof transparent cap and elongated cylindrical housing and is unscrewed to expose the micro USB connector for receipt of electrical energy through the micro USB connector that powers the light source.

9. The flashlight as in claim 8 wherein the light source further comprises an LED.

10. The flashlight as in claim 8 further comprising a rechargeable battery that stores energy received through the micro USB receptacle.

11. The flashlight as in claim 10 wherein the rechargeable battery further comprises a lithium ion battery.

12. The flashlight as in claim 10 further comprising a charge indicator light disposed adjacent the micro USB receptacle that indicates a charge state of the rechargeable battery.

13. The flashlight as in claim 12 further comprising a charge status circuit that activates the charge indicator light based upon the charge status of the rechargeable battery.

14. The flashlight as in claim 13 wherein the charge indicator light further comprises a flashing red indicator light activated by the charge status circuit when the charge state circuit detects that the rechargeable battery is less than fully charged.

15. The flashlight as in claim 13 wherein the charge indicator light further comprises a steady green indicator light that is activated when the charge status circuit detects that the rechargeable battery is fully charged.

16. The flashlight as in claim 8 further comprising first, second and third electrical terminals, the first terminal is of a first polarity and is located proximate the first end, the second terminal is of a second polarity and is proximate the second end, the first and second terminals are concentric with the longitudinal axis of the cylindrical housing and the third terminal is of the second polarity and is located adjacent the first terminal midway between the first terminal and wall of the cylindrical housing where the rechargeable battery receives charging energy through the first and third terminals and where the light source receives illuminating energy through the first and second terminals

17. A flashlight comprising:
a cylindrical housing having an external thread extending around the cylindrical housing proximate a first end;
a LED light source disposed on the first end of the housing with an axis of light transmission of the LED parallel to the predominant axis of the light housing;
an O-ring disposed around the housing spaced back from the first end;
a micro USB receptacle extending through the cylindrical housing between the external thread and O-ring;
a rechargeable battery within the cylindrical housing;
a selector switch and pushbutton extending axially from the second end of the housing, the selector switch having a first position where the LED is momentarily activated for each momentary activation of the pushbutton, the selector switch having a second position where the pushbutton is momentarily activated a first time to activate and maintain the LED light in an activated state, the pushbutton being momentarily activated a second time to deactivate the LED light;
a waterproof cap with a transparent lens covering the LED light source and first end of the housing, the cylindrical housing having an matching internal thread spaced back from an engaging end of the waterproof cap, the internal thread of the waterproof cap being threaded onto the external thread of the housing in a first direction to engage the O-ring to form a waterproof seal with the cylindrical housing, the waterproof cap being rotated in a second direction away from the O-ring to expose the USB receptacle thereby allowing the rechargeable battery to be charged via a charging current received through the USB receptacle.

18. The flashlight as in claim 17 further comprising first and second electrical terminals within the cylindrical housing proximate the first end, the first and second terminals delivering charging energy to the rechargeable battery.

19. The flashlight as in claim 18 further comprising a third electrical terminal proximate a second end of the cylindrical housing, the third electrical terminal and the one of the first and second electrical terminals delivering power from the rechargeable battery to the LED light source.

20. The flashlight as in claim 19 wherein the rechargeable battery further comprises first and second concentric charging terminals located on a first end and wherein one of the first and second terminals and a third terminal located on a second opposing end defines discharge terminals.
